(19) United States
(12) Patent Application Publication
(10) Pub. No.: US 2009/0228143 A1
(43) Pub. Date: Sep. 10, 2009

(54) METHOD AND APPARATUS FOR PRODUCING AND SELLING PAINT

(75) Inventors: Randall Hughes, Glendale, AZ (US); Mel Sauder, Mesa, AZ (US); Gretchen Lowery, Mesa, AZ (US); Robert Lowery, Mesa, AZ (US); David Philbrook, Chandler, AZ (US)

Correspondence Address: SCHMEISER OLSEN & WATTS, 18 E UNIVERSITY DRIVE, SUITE # 101, MESA, AZ, 85201, US

(73) Assignee: MICROBLEND TECHNOLOGIES, INC., Gilbert, AZ (US)

(21) Appl. No.: 12/043,065

(22) Filed: Mar. 5, 2008

(51) Int. Cl. G06F 17/00; C08K 3/22

(52) U.S. Cl. 700/239; 524/497

(57) ABSTRACT

A paint manufacturing system includes a paint component storage system in fluid communication with a dispenser. A computer system is operatively coupled to the dispenser through the paint component storage system, and a computer network is in communication with the computer system. The paint component storage system flows a desired amount of at least two paint components to the dispenser in response to a paint type indication provided to the computer system through the computer network.

### BACKGROUND OF THE INVENTION

1. Field of the Invention

This invention relates to a system for manufacturing a desired type and color of paint.

2. Description of the Related Art

Paint is generally manufactured at a paint manufacturing facility and then transported in separate containers to a point of sale, wherein each container contains one type and color of paint. Different types of paint typically include different types of paint components in various amounts. The type and amount of paint components included in the paint determines its characteristics, such as drying time, quality level, sheen, finish, texture, etc. For example, some types of paint have a flat finish and others have a high-gloss finish. Consumers often desire different types of paint in different colors, so an inventory of them is maintained at the point of sale to satisfy consumer needs.

However, there are several problems with maintaining an inventory of different types and colors of paint. One problem is that the inventory of paint occupies a significant amount of costly storage space. Another problem is that the properties of paint degrade over time. For example, paint has a tendency to settle the longer it is stored in the inventory. Paint settles when the mixture of paint components included therein become unmixed. If the paint degrades enough, it may be unsuitable for use and discarded, which leads to waste. Hence, it is desirable to use the paint before its properties degrade.

It is also very costly and labor intensive to keep track of the manufacturing dates of the different types of paint in the inventory. It is necessary to keep track of the manufacturing dates to determine which paint is suitable for use and which is not, so that the likelihood of selling paint that is suitable for use is increased. The inventory is often tracked by determining the number of paint containers containing a particular type and color of paint. Since it is labor intensive and costly to keep track of changes in the inventory, it is desirable to reduce this need.

Further, it is costly and labor intensive to maintain retail space at the point of sale for the consumer to select and purchase the desired type of paint having the desired color. Selecting and purchasing paint at the point of sale is costly because retail space is costly. Selecting and purchasing paint at the point of sale is labor intensive because paid workers generally spend time with the consumer to help him or her make their selection. Oftentimes, the worker spends time with the consumer who chooses to not make a purchase, so this time is wasted.

### BRIEF SUMMARY OF THE INVENTION

The present invention employs a paint manufacturing system for manufacturing a desired type and color of paint. The paint manufacturing system includes a computer system in communication with a computer network, wherein the computer system can be located at a point of sale. The consumer provides an indication, to the computer system through the computer network, of a desired type of paint and, in response, the paint manufacturing system dispenses a predetermined type and amount of paint components which form the desired type of paint. In some embodiments, the consumer provides an indication, to the computer system through the computer network, of a desired color of paint and, in response, the paint manufacturing system dispenses a predetermined type and amount of paint colorants which are combined with the desired type of paint.

In some embodiments, the consumer provides an indication, to the computer system through the computer network, of a desired additive and, in response the paint manufacturing system dispenses a predetermined type and amount of additive which is combined with the desired paint. Typically, the paint manufacturing system dispenses the paint components, colorants and/or additive after the consumer pays for the desired paint. In some situations, the consumer pays for the desired paint using the computer network.

The paint manufacturing system reduces the cost and amount of labor involved in providing the consumer with the desired paint because an inventory of different types of paint does not need to be maintained at the point of sale. Further, fewer workers are needed at the point of sale to help the consumer make their paint selection. Also, the consumer is more likely to make a purchase if he or she can select the type and color of paint they want. Further, the consumer is more likely to make a purchase if he or she can select the type and amount of additive they want the paint to include.

In one embodiment, the paint manufacturing system includes a dispenser in fluid communication with a paint component storage system and colorant storage system. The computer system is operatively coupled to the paint component and colorant storage systems because it controls the type and amount of paint components and colorants, respectively, the paint component and colorant storage systems flow to the dispenser.

The paint component storage system dispenses a desired type and amount of paint components in response to a paint type indication provided to the computer system through the computer network. The desired type and amount of paint components form a base paint of the desired paint. The dispenser dispenses at least two types of paint components in response to the paint type indication. The desired paint is formed in response to the paint components being dispensed.

The colorant storage system dispenses a desired type and amount of colorants in response to a paint color indication provided to the computer system through the computer network. It should be noted that different types of colorants have different colors. The types and amounts of colorants dispensed are chosen to drive the color of the base paint to a desired color. In this way, the desired type and color of paint is provided using a computer network.

In some embodiments, the paint manufacturing system includes an additive storage system in fluid communication with the dispenser. The computer system is operatively coupled to the additive storage system, because it controls the type and amount of additive(s) the additive storage system flows to the dispenser. It should be noted that the same dispenser can dispense the paint components, colorant(s) and additive(s), or the paint components, colorant(s) and additive(s) can be dispensed with separate dispensers.

The additive storage system dispenses a desired type and amount of additive(s) in response to a paint additive indication provided to the computer system through the computer network. In this way, the desired type and amount of additive(s) are provided using a computer network.

These and other features, aspects, and advantages of the present invention will become better understood with reference to the following drawings and description.

### BRIEF DESCRIPTION OF THE DRAWINGS

FIG. 1a is a block diagram of a paint manufacturing system, in accordance with the invention.

FIG. 1b is a block diagram of another embodiment of a paint manufacturing system, in accordance with the invention.

FIG. 2a is a perspective view of the paint manufacturing system of FIG. 1a.

FIG. 2b is a close-up perspective view of a portion of the paint manufacturing system of FIG. 2a.

FIG. 2c is a schematic diagram of the paint manufacturing system of FIG. 2a, showing a colorant storage system.

FIG. 2d is a schematic diagram of the paint manufacturing system of FIG. 2a, showing an additive storage system.

FIG. 3a is a perspective view of one embodiment of a dispenser, in accordance with the invention, included with the paint manufacturing system of FIG. 2a.

FIG. 3b is a bottom view of the dispenser of FIG. 3a.

FIG. 3c is a perspective view of a colorant nozzle included with the dispenser of FIG. 3a.

FIG. 3d is a perspective view of an additive nozzle included with the dispenser of FIG. 3a.

FIGS. 4a and 4b are perspective views of colorant and additive storage systems, respectively, in accordance with the invention, included with the paint manufacturing system of FIG. 2a.

FIGS. 4c and 4d are schematic diagrams of the colorant and additive storage systems of FIGS. 4a and 4b, respectively.

FIGS. 5a, 5b, 5c, 5d and 5e are block diagrams of a method, in accordance with the invention, of manufacturing a desired type of paint at a point of sale.

FIGS. 6a, 6b, 6c, 6d and 6e are block diagrams of a method, in accordance with the invention, of ordering a desired paint.

### DETAILED DESCRIPTION OF THE INVENTION

The present invention allows the manufacture of a desired type and color of paint at a point of sale in response to a remotely provided paint type and paint color indication, respectively. In this way, the desired type and color of paint is provided without the consumer having to be at the point of sale. Further, the present invention allows one or more additives to be added to the desired type and color of paint at the point of sale in response to a remotely provided paint additive indication. In this way, the additive is provided without the consumer having to be at the point of sale. There are many different types of additives that can be included with the paint. Some examples of additives include pearle essence, metallics, mildicide, as well as other aqueous additives.

However, the consumer can pay for the paint at the point of sale or remotely. Further, the consumer can pick up the paint at the point of sale or have it shipped to him or her. The point of sale can be at many different locations, such as a store and warehouse. Examples of stores include paint stores, as well as hardware and home improvement stores. The store is generally a retail store which provides the sale of goods and/or services.

Providing the paint type, color and additive indications remotely is useful for several reasons. Providing the paint type, color and additive indications remotely is useful because it is very labor intensive and costly to maintain retail space at a point of sale for the consumer to select and purchase the desired type and color of paint having the desired additive(s). Selecting and purchasing paint at the point of sale is labor intensive and costly because paid workers generally spend time with the consumer to help them make their selection.

Adding the additive to the paint at the point of sale is useful for many different reasons, with one reason being that it is desirable to control the type and amount added to the paint. Presently, the additive is added to the paint by pouring it into the paint from a separate container, wherein the amount of paint poured is difficult to control. The amount of additive it is desired to add to the paint often depends on the climate of the location the paint will be used, so it is desirable to be able to accurately add different amounts of additive.

Another problem is that the type and amount of additive desired in the paint cannot be easily changed once the additive is added to the paint. If the additive is added to the paint prior to purchase, the consumer has less control over the type and amount of additive in the paint being purchased. Further, in some situations, the effectiveness of the additive diminishes over time by settling, break down, etc., so it is often desirable to add the additive to the paint when the paint is sold, or shortly thereafter. It is also desirable to decrease the time between when the additive is added to the paint and when the paint is used.

Adding the additive to the paint at the point of sale is useful because it is undesirable to expose the consumer to the additive. It is undesirable to expose the consumer to the additive because some additives, such as mildicide, are toxic, so it is undesirable to have toxic additives added to paint by the consumer. A toxic additive added to the paint by pouring will emit fumes in response to being poured. Hence, it is desirable to add the additive to the paint so the amount of fumes emitted is reduced. Further, it is undesirable to have the consumer dispose of a container which contains the toxic additive. It is also undesirable to have the consumer dispose of an empty container which used to contain the toxic additive.

Manufacturing the paint at the point of sale is useful for several reasons, with one being that the desired paint can be manufactured in response to the desires of the consumer. Hence, the type and color of the paint, as well as the additive(s), can be selected by the consumer before the paint is manufactured. This allows the paint retailer to provide an “inventory on demand”, wherein an inventory of paint is produced in response to an indication that the consumer wants a particular type and color of paint. If the type and color of the paint produced is desired, the consumer is more likely to purchase it. Hence, the consumer is more likely to want paint and to purchase it if the paint is manufactured at the point of sale.

Manufacturing the paint at the point of sale is also useful because the paint is made and sold shortly thereafter. Hence, there is no need to maintain an inventory of paint without a purchaser for it. There is also no need to keep an inventory of different types and colors of paint from which the consumer makes a selection. It is also no longer necessary to keep track of changes in an inventory of paint. Manufacturing the paint at the point of sale is also useful because the paint manufacturing system typically occupies less space than an inventory of paint.

Manufacturing the paint at the point of sale is useful because of the decreased time the paint is stored. This is useful because paint is more likely to degrade as the time it is stored increases. The paint can degrade in many different ways, such as by settling. The paint can also degrade if it experiences undesirable temperature and humidity changes. If the paint degrades too much, it can be unsatisfactory for use. The paint can be unsatisfactory for use for many different reasons, such as if its color undesirably changes or if the amount of paint components included therein changes. The amount of paint components in the paint can undesirably change in many different ways, such as by evaporation. The relative amounts of the paint components can undesirably change over time when a paint component evaporates faster than others. If the relative amount of the paint components changes too much, the paint may be unsuitable for its intended purpose, such as for indoor or outdoor use. Hence, it is desirable to decrease the time between manufacturing and selling the paint, as well as the time between manufacturing and using the paint.

It should be noted that paint can include many different types of paint components, but it generally includes two or more different types of paint components. Each paint component typically includes many different types of materials combined together. It should also be noted that the paint components can be stored separately from each other for longer periods of time than a paint composed of them will. Further, the paint components do not degrade as quickly as paint composed of them will. Hence, it is desirable to store paint components in separate containers instead of in the same container, as is done with paint composed of the paint components.

Examples of paint components typically used to make paint include resin, pigment composition, and a dispersant thickening agent. The resin can be a material with a high or low resin content, wherein the high resin content material includes more resin than the low resin content material. These paint components often include water as the solvent, so they are considered to be aqueous based paint components. The paint components are combined together in different amounts to provide a base paint. The base paint is often colored to provide a desired type and color of paint. The paint components can be combined together in many different ways, such as by mixing. One way paint components are combined together is by shaking them so they mix.

There are many different types of base paints that can be made from the paint components. In one embodiment, the types of base paints include pastel, tinting, deep tone and neutral base paints. The pastel base paint has the lightest color and the neutral base paint has the darkest color. Further, the tinting base paint is lighter than the deep tone base paint, but darker than the pastel base paint. The deep tone base paint is darker than the tinting base paint, but lighter than the neutral base paint. These base paints are generally provided with a desired quality level and sheen. It should be noted that four types of base paints are discussed here for illustrative purposes. However, another number of base paints can also be manufactured.

In accordance with the invention, one or more colorants are combined with the base paint to provide it with the desired color, wherein the colorant(s) are provided by the paint manufacturing system. Hence, the desired paint generally includes the base paint and one or more colorants combined therewith. The colorant(s) are combined with the base paint by combining them with the paint components included therein. In this way, the color of the base paint is driven to the desired color. The colorant(s) can be combined with the paint components in many different ways, such as by mixing. One way paint components and colorant(s) are combined together is by shaking them so they mix. In this way, a desired type of paint is manufactured and provided with a desired color at the point of sale.

In accordance with the invention, one or more additives are combined with the base paint, wherein the additive(s) are provided by the paint manufacturing system. Hence, the desired paint generally includes the base paint and one or more additives combined therewith. The additive(s) are combined with the base paint by combining them with the paint components included therein. The additive(s) can be combined with the paint components in many different ways, such as by mixing. One way paint components and additive(s) are combined together is by shaking them so they mix. In this way, a desired type of paint which includes one or more desired additives is manufactured and provided at the point of sale.

More information regarding paint manufacturing systems, as well as paint and paint components, can be found in U.S. patent application Ser. Nos. 11/353,729, 11/757,264, 11/875,720 and 11/945,886 filed on Feb. 13, 2006, Jun. 1, 2007, Oct. 19, 2007 and Nov. 27, 2007, respectively, the contents of all of which are incorporated herein by reference. Information can also be found in U.S. Pat. Nos. 6,221,145, 6,969,190, 7,065,429 and 7,132,470 filed on Dec. 23, 1998, Nov. 1, 2002, Nov. 1, 2002 and Sep. 15, 2003, respectively, the contents of all of which are incorporated herein by reference.

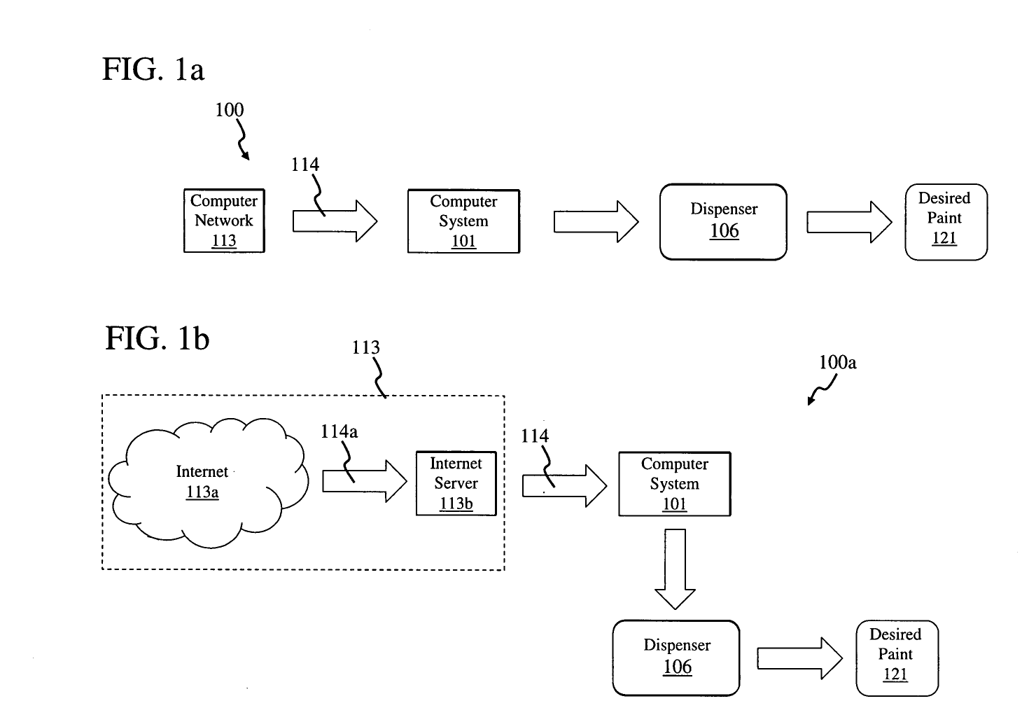

FIG. 1a is a block diagram of a paint manufacturing system 100, in accordance with the invention. In this embodiment, paint manufacturing system 100 includes a computer system 101 in communication with a computer network 113. Computer system 101 can be of many different types, such as a personal computer and laptop computer, and its operation will be discussed in more detail below. Computer network 113 can be of many different types, but it is generally a network of computer systems in communication with each other, as well as computer system 101. Examples of a computer network include the Internet, a local area network and wide area network.

It should be noted that computer system 101 is generally positioned at a point of sale, and computer network 113 is generally not positioned at the point of sale. In some examples, however, a portion of computer network 113 is positioned at the point of sale and is included with paint manufacturing system 100. For example, as discussed with FIG. 1b, computer network 113 can include an internet server that is positioned at the point of sale, wherein the internet server is included with paint manufacturing system 100. An internet server is a computer system that allows other computer systems to access data files, programs, records and peripheral devices through a computer network. An internet server can also process requests for text and multimedia documents, such as hypertext mark-up language (HTML) documents, that are typically associated with a web page.

Computer system 101 and computer network 113 can be in communication with each other in many different ways. In this embodiment, computer system 101 and computer network 113 are in communication with each other through a communication link 114, which allows the flow of signals between computer network 113 and computer system 101. Communication link 114 can be of many different types, such as a wireless or wired communication link. An example of a wireless communication link is a wireless modem and an example of a wired communication link is an Ethernet cable. The signals can be of many different types, such as those corresponding to digital data.

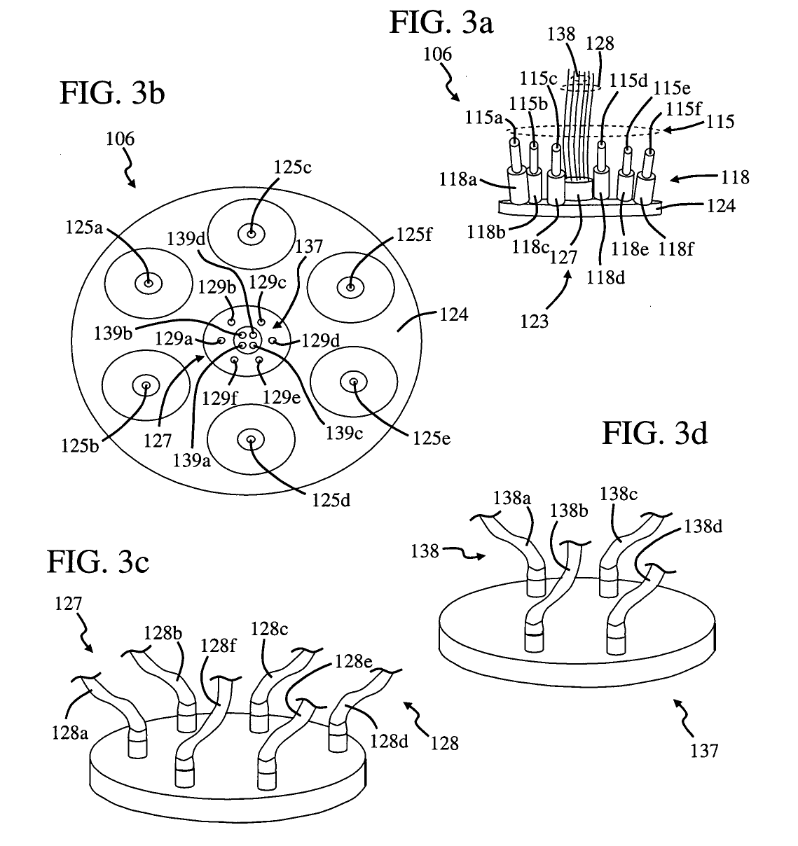

In this embodiment, paint manufacturing system 100 includes a dispenser 106 which is operatively coupled to computer system 101. More information regarding dispenser 106 is provided below with FIGS. 3a, 3b, 3c and 3d. In accordance with the invention, dispenser 106 dispenses a predetermined combination of paint components in response to a paint type indication being provided to computer system 101 through computer network 113 and communication link 114. Dispenser 106 dispenses at least two paint components in response to the paint type indication being provided to computer system 101. A desired paint 121 is formed in response to the paint components being dispensed by dispenser 106. In this way, computer system 101 is operatively coupled to a dispenser.

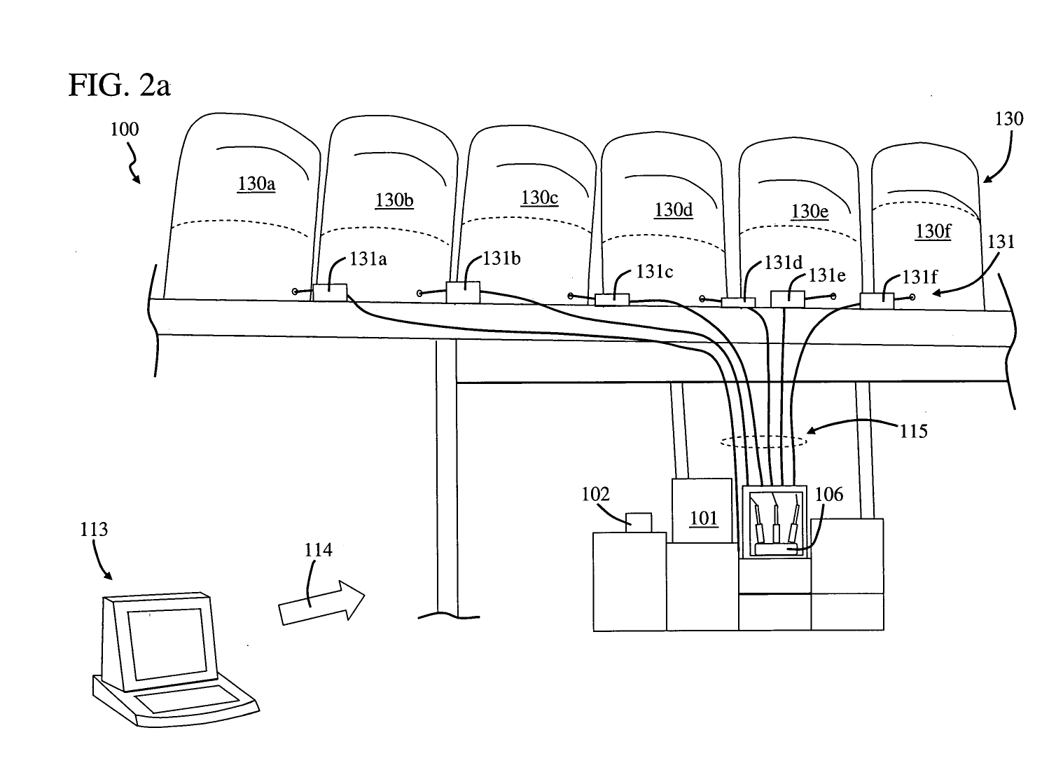

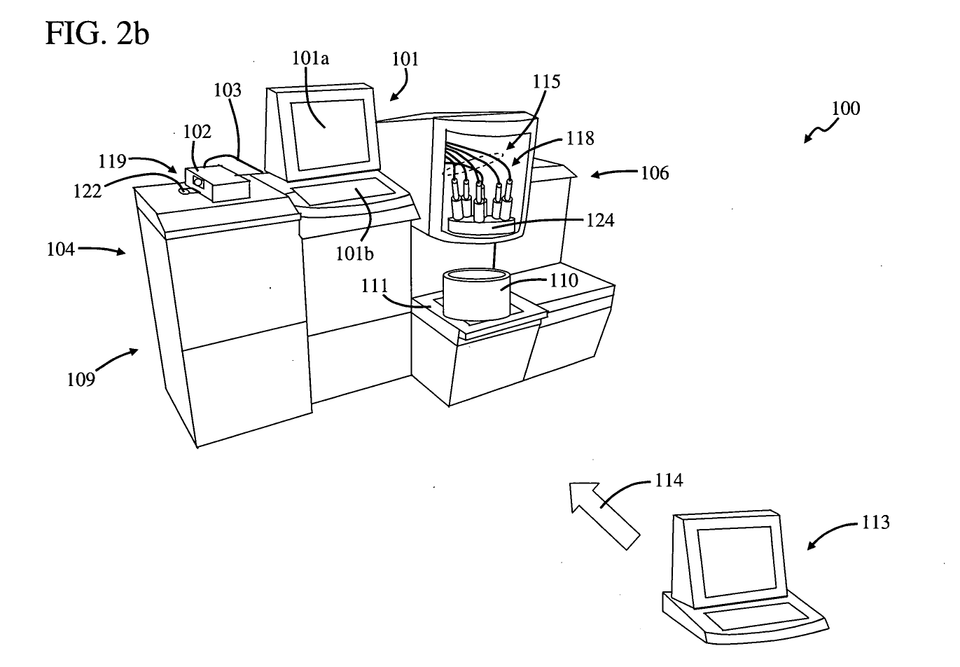

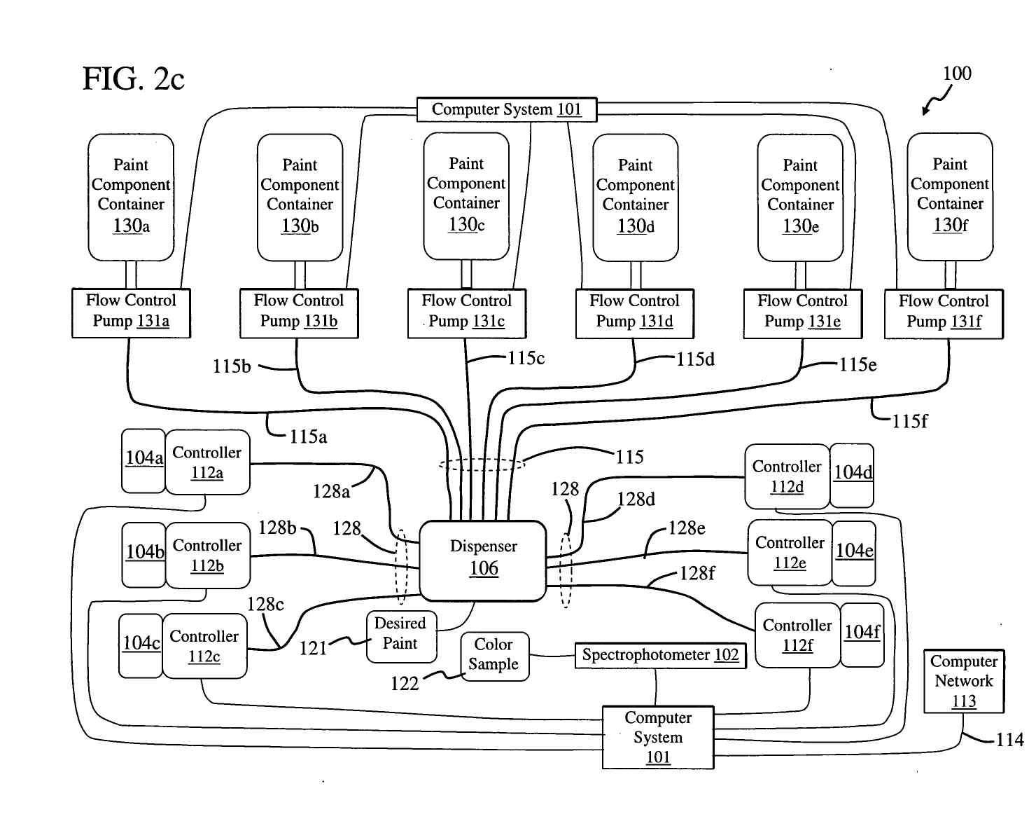

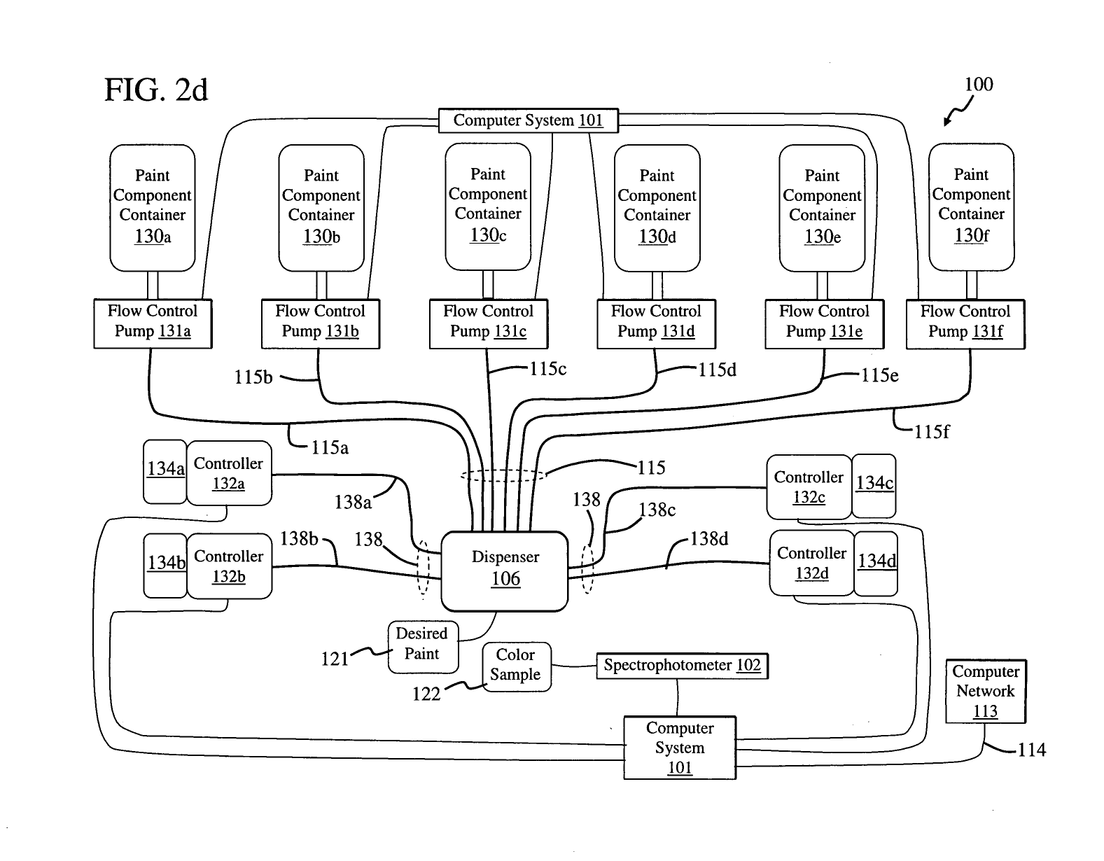

Dispenser 106 can dispense the paint components in response to the paint type indication being provided to computer system 101 in many different ways. In one embodiment, computer system 101 is operatively coupled to a paint component storage system (not shown), which is in fluid communication with dispenser 106. The paint component storage system flows the paint components to dispenser 106 in response to computer system 101 receiving the paint type indication through computer network 113 and communication link 114. In this way, computer system 101 is operatively coupled to a dispenser through a paint component storage system, and paint components are dispensed by paint manufacturing system in response to a paint type indication. More information regarding one embodiment of a paint component storage system is provided below with FIG. 2a and 2c.

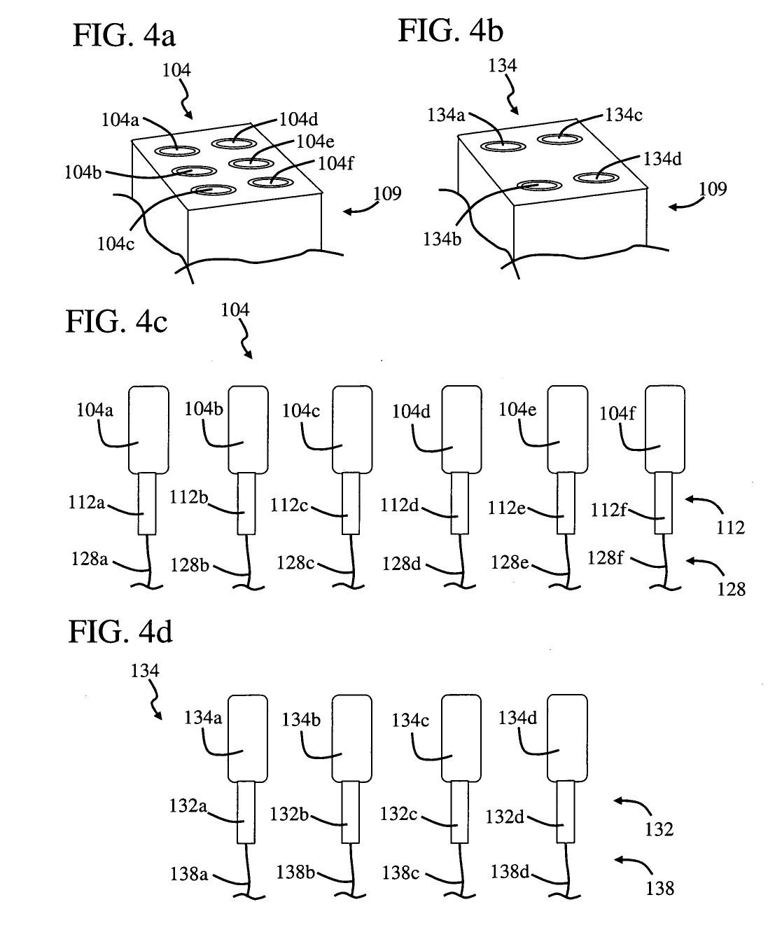

In some embodiments, paint manufacturing system 100 includes a colorant storage system (not shown) operatively coupled to computer system 101, wherein the colorant storage system is in fluid communication with dispenser 106. More information regarding one embodiment of a colorant storage system is provided below with FIGS. 4a and 4c. The colorant storage system flows a predetermined combination of colorant(s) to dispenser 106 in response to a paint color indication being provided to computer system 101. The paint color indication can be provided to computer system 101 in many different ways. In one embodiment, the paint color indication is provided to computer system 101 through computer network 113 and communication link 114. In this way, computer system 101 is operatively coupled to a dispenser through a colorant storage system, and one or more colorant are dispensed by paint manufacturing system in response to a paint color indication.

In some embodiments, paint manufacturing system 100 includes an additive storage system (not shown) operatively coupled to computer system 101, wherein the additive storage system is in fluid communication with dispenser 106. More information regarding one embodiment of an additive storage system is provided below with FIGS. 4b and 4d. The additive storage system flows a predetermined combination of additive(s) to dispenser 106 in response to a paint additive indication being provided to computer system 101. The paint additive indication can be provided to computer system 101 in many different ways. In one embodiment, the paint additive indication is provided to computer system 101 through computer network 113 and communication link 114. In this way, computer system 101 is operatively coupled to a dispenser through an additive storage system, and one or more additives are dispensed by paint manufacturing system in response to a paint additive indication.

FIG. 1b is a block diagram of a paint manufacturing system 100a, in accordance with the invention. In this embodiment, paint manufacturing system 100a includes computer system 101 and computer network 113 in communication with each other through communication link 114. As discussed above, computer system 101 is operatively coupled to dispenser 106, which dispenses the desired type and color of paint, as well as an additive, if desired. In this embodiment, computer network 113 includes Internet 113a and an internet server 113b in communication with each other through a communication link 114a, wherein communication link 114a can be the same or similar to communication link 114.

As mentioned above, computer system 101 is positioned at the point of sale. Further, in this embodiment, internet server 113b is also positioned at the point of sale. In this way, a portion of computer network 113 (i.e. internet server 113b) is positioned at the point of sale and another portion (i.e. Internet 113a) is not. It should be noted that, in some embodiments, internet server 113b is positioned so it is not at the point of sale. Further, in some embodiments, another portion of Internet 113a, other than internet server 113b, is positioned at the point of sale.

In operation, the consumer uses Internet 113a to access, through communication link 114a, a web page hosted by internet server 113b and selects the desired type and color of paint he or she desires, as well as any additives. When the paint is selected, internet server 113b provides this information to computer system 101 through communication link 114 and, in response, dispenser 106 dispenses the paint components and colorants, as well as the additives, to form desired paint 121.

It should be noted that the consumer can pay for desired paint 121 in many different ways. For example, the consumer can pay for desired paint 121 using Internet 113a to access, through communication link 114a, the web page hosted by internet server 113b. The consumer can also pay for desired paint 121 when he or she goes to the point of sale to pick it up. The consumer can pay for desired paint 121 after it is shipped to a desired location, such as his or her home or place of business.

In some situations, the consumer pays for desired paint 121 before its paint components are dispensed by dispenser 106 and, in other situations, the consumer pays for desired paint 121 after its paint components are dispensed by dispenser 106. In some situations, the consumer pays for desired paint 121 before its colorant(s) are dispensed by dispenser 106 and, in other situations, the consumer pays for desired paint 121 after its colorant(s) are dispensed by dispenser 106. In some situations, the consumer pays for desired paint 121 before its additive(s) are dispensed by dispenser 106 and, in other situations, the consumer pays for desired paint 121 after its additive(s) are dispensed by dispenser 106.

FIG. 2a is a perspective view of paint manufacturing system 100, in accordance with the invention, and FIG. 2b is a close-up perspective view of paint manufacturing system 100. FIGS. 2c and 2d are schematic diagrams of paint manufacturing system 100 showing a colorant storage system 104 and additive storage system 134, respectively. In this embodiment, paint manufacturing system 100 includes computer system 101 in communication with computer network 113 through communication link 114, as described above. Computer system 101 includes a monitor 101a and an input device 101b, wherein monitor 101a is embodied as a touch-screen monitor and input device 101b is embodied as a keyboard. Computer system 101 operates software that allows it to communicate with computer network 114 and allows it to control the operation of several paint manufacturing system components, such as a paint component storage system 130 (FIG. 2a), colorant storage system 104 (FIG. 2c) and additive storage system 134 (FIG. 2d). Paint component storage system 130, colorant storage system 104 and additive storage system 134 can be positioned at many different locations, but, in this embodiment, they are positioned at the point of sale. In this way, paint manufacturing system 100 is capable of providing the desired type and color of paint, as well as any additives, at the point of sale.

As mentioned above, the paint components, colorant(s) and/or additive(s) are predetermined in response to one or more indications provided to computer system 101. In some situations, the indications are provided to computer system 101 through monitor 101a and/or input device 101b. However, in accordance with the invention, the indications are provided to computer system 101 through computer network 113 and communication link 114. More information regarding the flow of information between computer system 101 and computer network 113 is provided above with FIGS. 1a and 1b.

As mentioned above, paint manufacturing system 100 includes dispenser 106, wherein the material dispensed by dispenser 106 is controlled by computer system 101, as will be discussed in more detail below. Dispenser 106 dispenses materials which form desired paint 121 and provide it with the desired color and additives.

In this embodiment, and as shown in FIG. 2b, dispenser 106 includes paint component nozzles 118 supported by a nozzle support structure 124. Nozzles 118 are connected to paint component storage system 130 through a paint component plumbing system 115, and dispense pre-selected paint components in response to an indication from computer system 101. Nozzles 118 dispense pre-selected paint components in response to the paint type indication being provided to computer system 101.

In this embodiment, paint component storage system 130 includes paint component storage containers 130a, 130b, 130c, 130d, 130e and 130f (FIG. 2a). It should be noted that six paint component containers are shown in this embodiment, but there are generally two or more. The number of paint component storage containers corresponds to the number of paint components system 100 is capable of providing. In one particular example, containers 130a, 130b, 130c and 130d each contain the pigment composition, dispersant thickening agent, high resin content binder and low resin content binder, respectively. In this way, each paint component storage container contains a material which consists essentially of a paint component. Further, in general, each paint component storage container of system 130 contains a material which consists essentially of a single type of paint component.

In this embodiment, paint component storage system 130 is in fluid communication with plumbing system 115 through a paint component mass flow controller system 131. Mass flow controller system 131 includes paint component mass flow controllers 131a, 131b, 131c, 131d, 131e and 131f. As shown in FIG. 2c, paint component containers 130a, 130b, 130c, 130d, 130e and 130f are in fluid communication with paint component hoses 115a, 115b, 115c, 115d, 115e and 115f, respectively, through mass flow controllers 131a, 131b, 131c, 131d, 131e and 131f, respectively. As shown in FIG. 2c, plumbing system 115 includes hoses 115a, 115b, 115c, 115d, 115e and 115f which allow paint components to flow between paint component storage system 130 and paint component nozzles 118 in response to the paint type indication being provided to computer system 101.

Computer system 101 controls the operation of mass flow controllers 131a-131f to control the amount of paint components which are allowed to flow through hoses 115a-115f, respectively. The operation of mass flow controllers 131a-131f can be controlled by computer system 101 in many different ways, such as by providing the paint type indication to system 101 through monitor 101a and/or input device 101b. In accordance with the invention, however, the operation of mass flow controllers 131a-131f is controlled by computer system 101 in response to the paint type indication being received by computer system 101 through computer network 113 and communication link 114. In this way, computer system 101 is operatively coupled to dispenser 106 through a paint component storage system, and paint components are dispensed by dispenser 106 in response to a paint type indication.

The paint components are dispensed through paint component nozzles 118 and into a paint container 110. Paint container 110 can be of many different types, such as a paint bucket, which allows the paint to be contained and carried away from the point of sale. In this embodiment, paint container 110 is supported on a paint weight scale 111, which determines the weight of paint container 110 combined with the weight of the material, such as the paint components, colorants and/or additives, dispensed through dispenser 106. Scale 111 can be of many different types, such as the PANTHER and PANTHER PLUS weighing terminals made by Mettler Toledo of Toledo, Ohio.

FIG. 3a is a perspective view of one embodiment of dispenser 106, in accordance with the invention, and FIG. 3b is a bottom view of dispenser 106 looking in a direction 123 of FIG. 3a. In this embodiment, paint component nozzles 118 includes six paint component nozzles, denoted as nozzles 118a, 118b, 118c, 118d, 118e and 118f. Nozzles 118a, 118b, 118c, 118d, 118e and 118f are supported by nozzle support structure 124 and are in fluid communication with paint component storage system 130 through hoses 115a, 115b, 115c, 115d, 115e and 115f, respectively, of plumbing system 115. In this way, nozzles 118a, 118b, 118c, 118d, 118e and 118f are in fluid communication with paint component containers 130a, 130b, 130c, 130d, 130e and 130f, respectively. It should be noted that hoses 115a-115f terminate at paint component openings 125a, 125b, 125c, 125d, 125e and 125f, respectively, as shown in FIG. 3b. Openings 125a-125f extend through a bottom surface of nozzle support structure 124 so that the respective paint components are outputted through them and into paint container 110.

In this embodiment, dispenser 106 includes a colorant nozzle 127, as shown in a perspective view in FIG. 3c, carried by nozzle support structure 124. Colorant nozzle 127 is connected to colorant storage system 104 through a colorant plumbing system 128 (FIG. 3a). Plumbing system 128 allows colorant components to flow between colorant storage system 104 and colorant nozzle 127. Plumbing system 128 includes six colorant hoses, denoted as hoses 128a, 128b, 128c, 128d, 128e and 128f, which extend through nozzle 127 and terminate at colorant openings 129a, 129b, 129c, 129d, 129e and 129f, respectively, as shown in FIG. 3b. It should be noted that the number of hoses in plumbing system 128 typically corresponds to the number of colorants included in colorant storage system 104. The colorant components are dispensed through openings 129a-129f and into paint container 110 wherein they are combined with the paint components. As will be discussed in more detail below with FIGS. 4a and 4c, the flow of colorants through plumbing system 128 is controlled by computer system 101. In particular, the colorants are flowed through plumbing system 128 in response to the paint color indication being provided to computer system 101. In this way, computer system 101 is operatively coupled to dispenser 106 through a colorant storage system.

In this embodiment, dispenser 106 includes an additive nozzle 137, as shown in a perspective view in FIG. 3d, carried by nozzle support structure 124. It should be noted that additive nozzle 137 is shown as extending through colorant nozzle 127 for illustrative purposes. However, additive nozzle 137 can be positioned at other locations of nozzle support structure 124. Additive nozzle 137 is connected to additive storage system 134 through an additive plumbing system 138 (FIG. 3a). Plumbing system 138 allows additives to flow between additive storage system 134 and colorant nozzle 137. Plumbing system 138 includes four additive hoses, denoted as hoses 138a, 138b, 138c and 138d (FIG. 3d), which extend through nozzle 137 and terminate at nozzle openings 139a, 139b, 139c and 139d, respectively, as shown in FIG. 3b. It should be noted that the number of hoses in plumbing system 138 typically corresponds to the number of additives included in additive storage system 134. The additives are dispensed through openings 139a-139f and into paint container 110 wherein they are combined with the paint. As will be discussed in more detail with FIGS. 4b and 4d, the flow of additives through plumbing system 138 is controlled by computer system 101. In particular, the additives are flowed through plumbing system 128 in response to the paint additive indication being provided to computer system 101. In this way, computer system 101 is operatively coupled to dispenser 106 through an additive storage system.

FIGS. 4a and 4b are perspective views of one embodiment of colorant storage system 104 and additive storage system 134, respectively, in accordance with the invention. Further, FIGS. 4c and 4d are schematic diagrams of colorant storage system 104 and additive storage system 134, respectively. It should be noted that colorant storage system 104 and additive storage system 134 are typically housed by paint manufacturing system 100 in a colorant storage cabinet 109, as shown in FIG. 2b, although they can be housed elsewhere.

In this embodiment, colorant storage system 104 is connected to plumbing system 128 through a colorant mass flow control system 112. Colorant storage system 104 includes colorant storage containers 104a, 104b, 104c, 104d, 104e and 104f and mass flow control system 112 includes colorant mass flow controllers 112a, 112b, 112c, 112d, 112e and 112f. Colorant storage containers 104a, 104b, 104c, 104d, 104e and 104f are connected to colorant hoses 128a, 128b, 128c, 128d, 128e and 128f, respectively, through mass flow controllers 112a, 112b, 112c, 112d, 112e and 112f, respectively.

Computer system 101 controls the operation of colorant mass flow controllers 112a-112f to control the amount of colorants which are allowed to flow through corresponding colorant hoses 128a-128f. The operation of mass flow controllers 112a-112f can be controlled by computer system 101 in many different ways, such as by providing the paint color indication to system 101 through monitor 101a and/or input device 101b. In accordance with the invention, however, the operation of colorant mass flow controllers 112a-112f is controlled by computer system 101 in response to the paint color indication being received by computer system 101 through computer network 113 and communication link 114. In this way, computer system 101 is operatively coupled to dispenser 106 through a colorant storage system, and colorants are dispensed by dispenser 106 in response to a paint color indication.

Colorant containers 104a-104f each contain a type of colorant which can be flowed into paint container 110 through colorant hoses 128a-128f and corresponding openings 129a-129f (FIG. 3b), as discussed above, wherein they are combined with the paint components contained in container 110. In this way, the color of the paint components contained in container 110 is driven to the desired color.

It should be noted that, in this embodiment, colorant storage system 104 is shown as including six colorant containers for illustrative purposes, so it can provide six colors, as well as their corresponding color combinations. A color combination is two or more colors combined together to provide a shade of color. The two or more colors can be combined together in many different ways, such as by mixing. In other embodiments, however, colorant storage system 104 includes fewer or more colorants. For example, in one particular embodiment, colorant storage system 104 includes twelve colorant containers, so it can provide twelve colors, as well as their corresponding color combinations. In general, the number of colorant containers included in colorant storage system 104 determines the number of different colors and shades of colors that can be provided. The number of different colors and shades of colors that can be provided increases with the number of colorant containers. Further, the number of different colors and shades of colors that can be provided decreases with the number of colorant containers. The amount and colors of colorants flowed into paint container 110 can be determined in many different ways, a few of which will be discussed in more detail below.

In this embodiment, additive storage system 134 is connected to additive plumbing system 138 through an additive mass flow control system 132. Additive storage system 104 includes additive storage containers 134a, 134b, 134c and 134d and mass flow control system 132 includes additive mass flow controllers 132a, 132b, 132c and 132d. Additive storage containers 134a, 134b, 134c and 134d are connected to hoses 138a, 138b, 138c and 138d, respectively, through mass flow controllers 132a, 132b, 132c and 132d, respectively.

Further, computer system 101 controls the operation of mass flow controllers 132a-132d to control the amount of additives which are allowed to flow through corresponding hoses 138a-138d. The operation of mass flow controllers 132a-132d can be controlled by computer system 101 in many different ways, such as by providing the paint additive indication to system 101 through monitor 101a and/or input device 101b. In accordance with the invention, however, the operation of mass flow controllers 132a-132d is controlled by computer system 101 in response to the paint additive indication being received by computer system 101 through computer network 113 and communication link 114. In this way, computer system 101 is operatively coupled to dispenser 106 through an additive storage system and additives are dispensed by dispenser 106 in response to a paint additive indication.

Additive containers 134a-134d each contain a type of additive which can be flowed into paint container 110 through hoses 138a-138d and corresponding openings 139a-139d (FIG. 3b), as discussed above, wherein they are combined with the paint components contained in container 110. The additive(s) can be combined with the paint components in many different ways, such as by mixing.

It should be noted that, in this embodiment, additive storage system 134 is shown as including four additive containers for illustrative purposes, so it can provide four types of additives, as well as combinations thereof. In other embodiments, however, additive storage system 134 can include fewer or more additive containers. For example, in one particular embodiment, additive storage system 134 includes six additive containers, so it can provide six additives, as well as combinations thereof. In general, the number of additive containers included in additive storage system 134 determines the number of different additives and combinations of additives that can be provided. The number of different additives that can be provided increases with the number of additive containers. Further, the number of different additives that can be provided decreases with the number of additive containers. The type and amount of additives flowed into paint container 110 can be determined in many different ways, a few of which will be discussed in more detail presently.

In operation, computer system 101 has access to a paint data file, which generally includes paint color and paint type information. In this embodiment, the paint color and paint type information are included in the same data file. However, the paint color and paint type information can be included with a paint color data file and a paint type data file, respectively, so that the paint data file includes separate data files. Further, computer system 101 has access to a paint additive date file which corresponds to a desired type of additive to be added to the paint components. The additive data file can be included with the paint data file which includes the paint color and/or paint type information, or the additive data file can be a separate data file.

The paint color and paint type information can be read and changed, if desired, by computer system 101. In some situations, the paint color and paint type information can be changed in response to a signal received by computer system 101 through monitor 101a and/or input device 101b. However, in accordance with the invention, the paint color and paint type information can be changed in response to a signal received by computer system 101 through computer network 113 and communication link 114. In one particular embodiment, the paint color and/or paint type information are changed in response to a signal received by computer system 101 through internet server 113b and communication link 114.

The paint data file can be an existing data file, or it can be created or changed in response to the paint type, paint color and/or paint additive indications provided to computer system 101. The changes to the paint data file can be made by sending one or more signals to computer system 101 through computer network 113 and communication link 114. Further, the paint color, paint type and/or paint additive data files can be existing data files, or they can be created or changed in response to the paint color, paint type and paint additive indications, respectively. The paint data file, color data file, paint type data file and/or paint additive data file can be stored internally with computer system 101 or externally to it, such as with internet server 113b.

In some embodiments, the paint color, paint type and/or paint additive indications are stored by the consumer on internet server 113b. In these embodiments, the consumer can create a user account on internet server 113b and store information corresponding to the paint color, paint type and paint additive indications for later use. This is useful when the consumer desires to purchase paint corresponding to the same type and color of paint they previously purchased, wherein the paint includes the same type and amount of additive.

The color data file includes paint color information which corresponds to the desired color of the paint manufactured with paint manufacturing system 100. The paint color information often represents the desired color in terms of a particular color scale. There are many different color scales that can be used to represent the desired color, with one being the Hunter color scale. The Hunter color scale represents colors with three color values, denoted as L, a and b. Hence, the paint color information can include L, a and b values corresponding to the desired color.

The paint type data file includes paint type information which corresponds to the desired type of the paint manufactured with paint manufacturing system 100. It should be noted that the desired type of paint includes a base paint, and the base paint typically depends on the desired color of paint. This is because the colorants are combined with the base paint to provide the paint with a desired shade of color. For example, if a dark color is desired, the paint type indication generally corresponds to a neutral base paint. If a light color is desired, the paint type indication generally corresponds to a pastel base paint. Colorants are combined with the base paint to provide a shade of color between pastel and neutral. Hence, the paint color indication depends on the paint type indication and the color data file depends on the paint type data file.

As mentioned above, the paint type, paint color and paint additive indications can be provided to computer system 101 in many different ways. In accordance with the invention, the paint type, paint color and paint additive indications are provided to computer system 101 by computer network 113 through communication link 114. In other situations, the paint type, paint color and paint additive indications are provided to computer system 101 by providing corresponding input through monitor 101a and/or input device 101b. The paint type, paint color and paint additive indications are generally provided to computer system 101 in response to an indication that a consumer desires a particular type and color of paint, which includes the desired additive. The paint type, paint color and paint additive data files are selected in response to the paint type, paint color and paint additive indications, respectively, provided to computer system 101.

In one situation, the paint type and paint color indications are provided to computer system 101 in response to one or more inputs provided to computer system 101 through computer network 113 and communication link 114. A paint type data file is selected in response to the paint type indication. The selected paint type data file corresponds to a base paint having a color associated with the color indicated by the paint color indication. A color data file is selected in response to the desired paint color indication. The selected color data file corresponds to the type and amount of colorants that will drive the color of the base paint, when combined therewith, to the desired color. In this way, the desired type of paint having the desired color is manufactured, by using a paint manufacturing system, in response to a remote indication that a consumer wants a desired paint.

If desired, the additive can be added to the base paint, as described in more detail above. For example, the additive can be added to the base paint by providing the paint additive indication to computer system 101 through computer network 113 and communication link 114. Further, the additive can be added to the base paint by providing the paint additive indication to computer system 101 through monitor 101a and/or input device 101b.

In another situation, the paint type and paint color indications are provided to computer system 101 in response to one or more inputs provided to computer system 101 through monitor 101a and/or input device 101b. A paint type data file is selected in response to the paint type indication. The selected paint type data file corresponds to a base paint having a color associated with the color indicated by the paint color indication. In response to the desired paint color indication, a color data file is selected. The selected color data file corresponds to the type and amount of colorants that will drive the color of the base paint, when combined therewith, to the desired color. In this way, the desired type of paint having the desired color is manufactured, by using paint manufacturing system 100, in response to an indication that a consumer wants a desired paint. In other situations, however, the paint color indication is provided to computer system 101 with a colorant signal, as will be discussed in more detail below. If desired, the additive can be added to the base paint by providing the paint additive indication to computer system 101 through monitor 101a and/or input device 101b.

In one situation, the paint type, paint color, and paint additive indications are provided to computer system 101 in response to one or more inputs provided to computer system 101 through monitor 101a and/or input device 101b. A paint type data file is selected in response to the paint type indication. The selected paint type data file corresponds to a base paint having a color associated with the color indicated by the paint color indication. In response to the desired paint color indication, a color data file is selected. The selected color data file corresponds to the type and amount of colorants that will drive the color of the base paint, when combined therewith, to the desired color. Further, a paint additive data file is selected in response to the paint additive indication. The selected paint additive indication corresponds to the desired type and amount of additive to be added to the paint components. In this way, the desired type of paint having the desired color and additive is manufactured, by using paint manufacturing system 100, in response to an indication that a consumer wants a desired paint. In other situations, however, the paint color indication is provided to computer system 101 with a colorant signal, as will be discussed in more detail presently.

As shown in FIG. 2b, paint manufacturing system 100 includes a spectrophotometer 102 in communication with computer system 101. Spectrophotometer 102 can be in communication with computer system 101 in many different ways, but a cable 103 is used here. In this way, computer system 101 and spectrophotometer 102 are operatively coupled together so signals can flow between them. Spectrophotometer 102 can be of many different types, such as those available from Greta Macbeth, MatchRite and Datacolor. Examples of spectrophotometers are also disclosed in U.S. Pat. Nos. 6,002,488 and 6,198,536.

Spectrophotometer 102 includes a sample holder 119 for holding a color sample 122. Color sample 122 can be of many different types, but it is often a color card corresponding to the desired color. In this way, the color of color sample 122 corresponds to the desired color of paint to be manufactured using paint manufacturing system 100.

In operation, spectrophotometer 102 flows a colorant signal S_{Colorant} to computer system 101 through cable 103, wherein colorant signal S_{Colorant} corresponds to the reflectance of color sample 122. The reflectance of color sample 122 corresponds to its paint color information. In response to colorant signal S_{Colorant}, computer system 101 stores the paint color information. The paint color information can be stored in many different locations, such as with the paint data file or an existing or created color data file. In this way, computer system 101 has access to paint color information corresponding to the color of color sample 122.

Once computer system 101 has access to the desired paint type and color information, computer system 101 determines the paint components and colorants needed to drive the color of the paint components to match the desired color. In this way, computer system 101 determines the paint components and colorants needed to drive the color of the base paint to match the desired color. It should be noted that, in accordance with the invention, the paint components and colorants are determined before they are dispensed. However, in some embodiments, the paint components and colorants can be determined after one or more of them are dispensed. For example, the paint components can be dispensed before the colorants are determined. It should be noted that it is generally desirable to decrease the amount of time between when the paint components and colorants are dispensed to preserve the quality of the paint.

After the paint type and colorants have been determined, computer system 101 provides an indication to mass flow control system 131 so that paint component storage system 130 dispenses the selected paint components. More information regarding the mass flow control system and paint component storage system is provided with FIGS. 2a and 2c. The selected paint components are dispensed by dispenser 106 to form the base paint, which is contained by container 110. Computer system 101 also provides an indication to mass flow control system 112 so that colorant storage system 104 dispenses the selected colorants. The selected colorants are dispensed by dispenser 106 into container 110 to drive the color of the base paint to match the desired color. If the color indication is provided by selecting the color data file, the color is driven to match the color corresponding to the paint color information included therein. If the color indication is provided by signal S_{Colorant}, the color is driven to match the color of color sample 122. In this way, the paint color indication can be provided to computer system 101 by using a spectrophotometer and a color sample.

It should be noted that the colorants can be selected in many different ways. For example, they can be selected to provide a desired accuracy in matching the color of the paint to the color of color sample 122. The colorants can also be selected based on cost. This is useful because some colorants are more expensive than others. Hence, the colorants can be selected to reduce costs, as well as the accuracy in color matching. The colorants can also be chosen in response to a desired use. For example, some colorants are better suited for outdoor use and other colorants are better suited for indoor use.

The program operated by computer system 101 determines the type of paint components, as well as their amounts, necessary to make the desired type of paint. In response to the determination of the type of paint components, computer system 101 operates flow control system 131 so that paint component storage system 130 flows the amount and type of paint components to dispenser 106 through plumbing system 115. The paint components are dispensed by nozzles 118 into paint container 110, as described above, to form desired paint 121. In this way, nozzles 118 dispense pre-selected paint components in response to an indication from computer system 101. The amount of paint components dispensed can be determined in many different ways, such as by volume and weight. In this embodiment, however, the paint components are dispensed by weight, as determined by paint weight scale 111.

As discussed above, desired paint 121 can be provided with a desired color by using color sample 122 and spectrophotometer 102 or by using a color data file. In the situation in which color sample 122 and spectrophotometer 102 are used, color sample 122 is held by sample holder 119 and spectrophotometer 102 flows colorant signal S_{Colorant} to computer system 101 through cable 103. Computer system 101 receives signal S_{Colorant} and determines the amount and color of the colorants needed to drive the color of the paint component combination contained by container 110 to match the color of color sample 122. The amount of paint colorants dispensed can be determined in many different ways, such as by volume and weight. In this embodiment, however, the colorants are dispensed by volume, as determined by colorant mass flow control system 112.

In response to the determination of the colorants, computer system 101 operates colorant mass flow control system 112 so that colorant storage system 104 flows the amount and color of colorants to dispenser 106 through plumbing system 128. The colorants are dispensed by colorant nozzle 127 into paint container 110 so that desired paint 121 is provided with a desired color. In this way, plumbing system 128 allows colorant components to flow between colorant storage system 104 and colorant nozzle 127 in response to an indication from computer system 101.

In the situation in which the color data file is used, the color data file is selected and it provides data to computer system 101 that corresponds to the desired color. The color data file can be selected using an input device such as monitor 101a and/of keyboard 101b. However, in accordance with the invention, the color data file can be selected using computer network 113. Colorant storage system 104 dispenses the colorants so, when combined with the paint components, the combination has a color driven to match the color represented by the color data file. Hence, the paint color indication can be provided to computer system 101 by selecting the color data file that corresponds with the desired color.

If desired, one or more additives can be added to the paint components, as discussed in more detail above. For example, in response to the paint additive indication, computer system 101 operates additive mass flow control system 132 so that additive storage system 134 flows the type and amount of additive(s) to dispenser 106 through additive plumbing system 138. The additive(s) are dispensed by additive nozzle 137 into paint container 110 so that desired paint 121 is provided with the desired additive(s). In this way, additive plumbing system 138 allows one or more additives to flow between additive storage system 134 and additive nozzle 137 in response to an indication from computer system 101.

In the situation in which the additive data file is used, the additive data file is selected and it provides data to computer system 101 which corresponds to the desired type and amount of additive(s) to be added to desired paint 121. The additive data file can be selected using an input device such as monitor 101a and/of keyboard 101b. However, in accordance with the invention, the additive data file can be selected using computer network 113. Additive storage system 134 dispenses the additive(s) so they are added to the paint components and combined therewith. Hence, the paint additive indication can be provided to computer system 101 by selecting the additive data file that corresponds with the desired type and amount of additive(s).

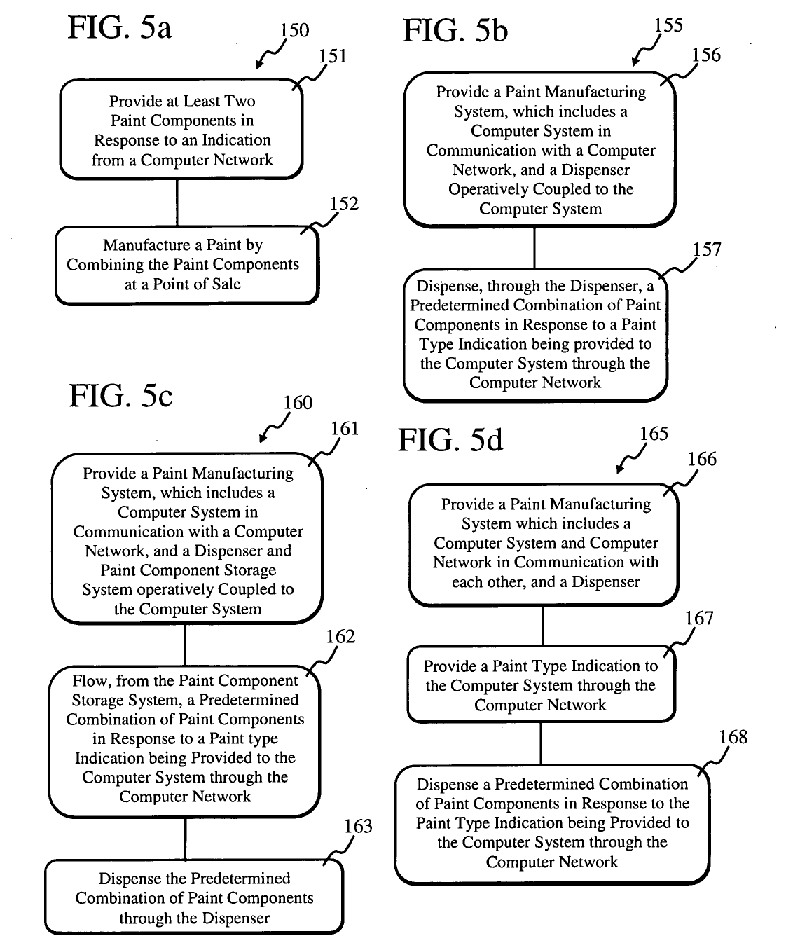

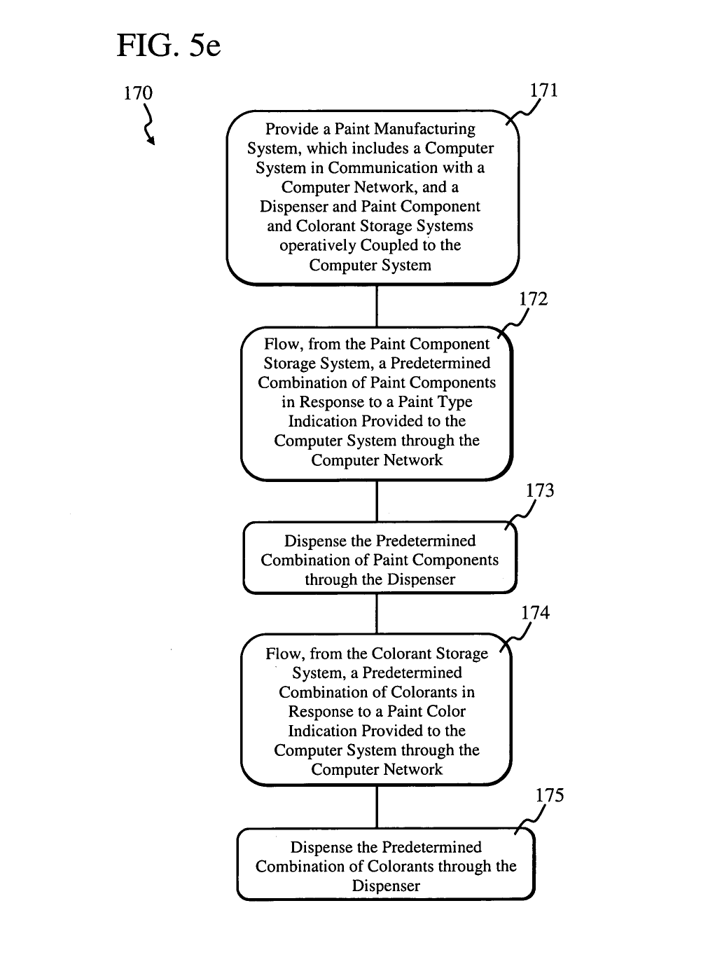

FIG. 5a is a block diagram of a method 150, in accordance with the invention, of manufacturing paint. In this embodiment, method 150 includes a step 151 of providing at least two paint components in response to an indication from a computer network, and a step 152 of manufacturing a paint by combining the paint components at a point of sale. In accordance with the invention, the paint components are provided by a paint manufacturing system. Further, the paint components are contained in separate paint component containers before they are combined. The paint components can be combined in many different ways, such as by mixing. In accordance with the invention, the paint components are selected from a group that includes a pigment composition, a dispersant thickening agent, and a resin content binder. It should be noted that the resin content binder can be a material with a high or low resin content, wherein the high resin content material includes more resin than the low resin content material. In one particular embodiment, the paint components include a resin content binder, and a pigment composition and/or dispersant thickening agent.

FIG. 5b is a block diagram of a method 155, in accordance with the invention, of manufacturing a desired type of paint. In this embodiment, method 155 includes a step 156 of providing a paint manufacturing system, which includes a computer system in communication with a computer network, and a dispenser operatively coupled to the computer system. It should be noted that the dispenser and computer system are typically located at the point of sale. Further, a portion of the computer network, such as an internet server, can be located at the point of sale.

Method 155 includes a step 157 of dispensing, through the dispenser, a predetermined combination of paint components in response to a paint type indication being provided to the computer system through the computer network. The desired paint is formed in response to the paint components being dispensed. The dispenser dispenses at least two paint components in response to the paint type indication. It should be noted that the paint components are dispensed at the point of sale.

FIG. 5c is a block diagram of a method 160, in accordance with the invention, of manufacturing a desired type of paint. In this embodiment, method 160 includes a step 161 of providing a paint manufacturing system, which includes a computer system in communication with a computer network, and a dispenser and paint component storage system operatively coupled to the computer system. It should be noted that the computer system, dispenser and paint component storage system are typically located at the point of sale. Method 160 includes a step 162 of flowing, from the paint component storage system, a predetermined combination of paint components in response to a paint type indication being provided to the computer system through the computer network. Method 160 includes a step 163 of dispensing the predetermined combination of paint components through the dispenser. The desired paint is formed in response to the paint components being dispensed. The dispenser dispenses at least two paint components in response to the paint type indication.

FIG. 5d is a block diagram of a method 165, in accordance with the invention, of manufacturing paint. In this embodiment, method 165 includes a step 166 of providing a paint manufacturing system which includes a computer system and computer network in communication with each other, and a dispenser. Method 165 includes a step 167 of providing a paint type indication to the computer system through the computer network. Method 165 includes a step 168 of dispensing a predetermined combination of paint components in response to the paint type indication being provided to the computer system through the computer network. The desired paint is formed at the point of sale in response to the paint components being dispensed.

In some embodiments, the paint manufacturing system of method 165 includes a colorant storage system operatively coupled to the computer system, wherein the colorant storage system is in fluid communication with the dispenser. In these embodiments, method 165 can include flowing a predetermined combination of colorants from the colorant storage system to the dispenser in response to a paint color indication. The paint color indication is provided to the computer system through the computer network. The colorants are dispensed by the dispenser and combined with the paint components.

In some embodiments, the paint manufacturing system of method 165 includes an additive storage system operatively coupled to the computer system, wherein the additive storage system is in fluid communication with the dispenser. In these embodiments, method 165 can include flowing a predetermined additive from the additive storage system to the dispenser in response to a paint additive indication. The paint additive indication is provided to the computer system through the computer network. The predetermined additive is dispensed by the dispenser and combined with the paint components.

FIG. 5e is a block diagram of a method 170, in accordance with the invention, of manufacturing a desired type and color of paint. In this embodiment, method 170 includes a step 171 of providing a paint manufacturing system, which includes a computer system in communication with a computer network, and a dispenser and paint component and colorant storage systems operatively coupled to the computer system. It should be noted that the computer system, dispenser and paint component and colorant storage systems are typically located at the point of sale. Further, a portion of the computer network, such as an internet server, can be located at the point of sale.

Method 170 includes a step 172 of flowing, from the paint component storage system, a predetermined combination of paint components in response to a paint type indication being provided to the computer system through the computer network. Method 170 includes a step 173 of dispensing the predetermined combination of paint components through the dispenser. The desired paint is formed in response to the paint components being dispensed. The dispenser dispenses at least two paint components in response to the paint type indication. Method 170 includes a step 174 of flowing, from the colorant storage system, a predetermined combination of colorants in response to a paint color indication provided to the computer system through the computer network. Method 170 includes a step 175 of dispensing the predetermined combination of colorants through the dispenser. The colorants are combined with the paint components. The combination of colorants drives the color of the paint components to match the desired color.

In some embodiments, the paint manufacturing system of method 170 includes an additive storage system operatively coupled to the computer system, wherein the additive storage system is in fluid communication with the dispenser. In these embodiments, method 170 can include flowing a predetermined combination of additive(s) from the additive storage system to the dispenser in response to a paint additive indication. The paint additive indication is provided to the computer system through the computer network. The additive(s) are dispensed by the dispenser and combined with the paint components. It should be noted that the predetermined combination of additive(s) can be one or more additives.

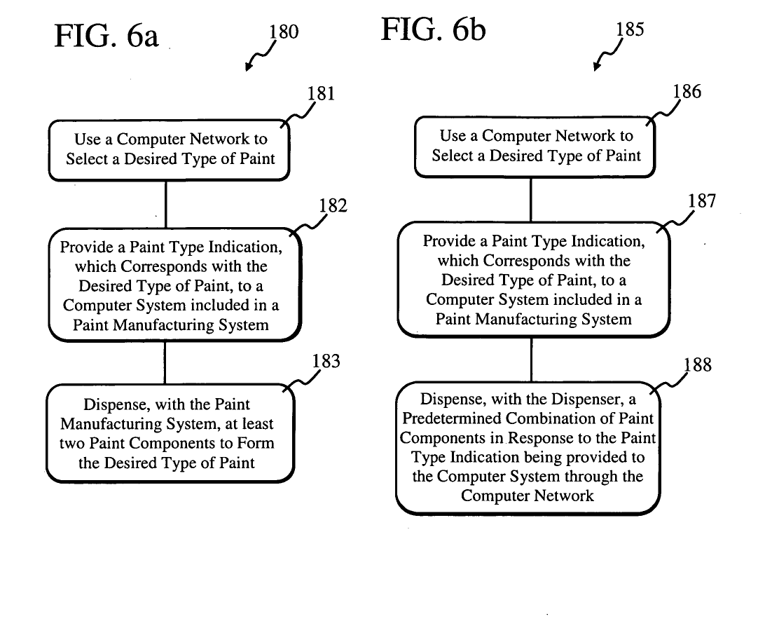

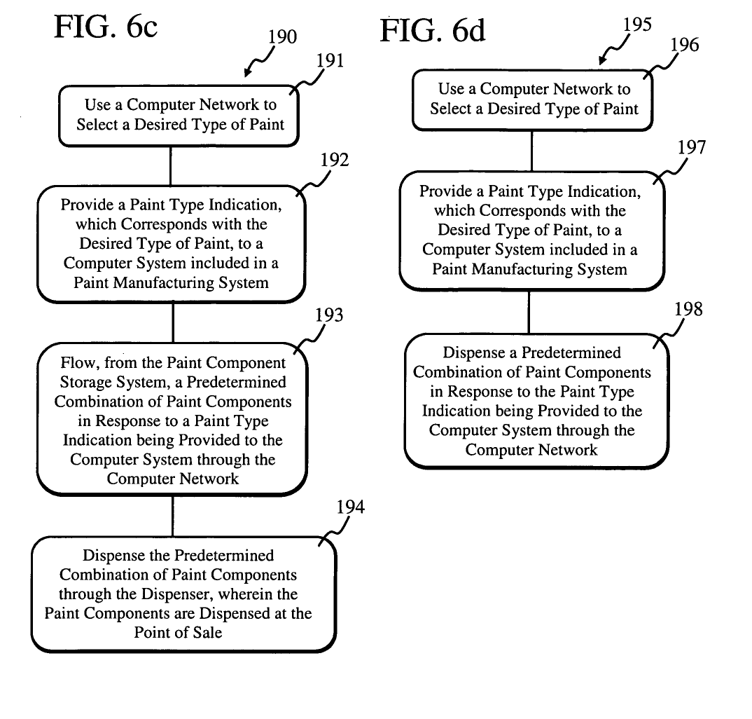

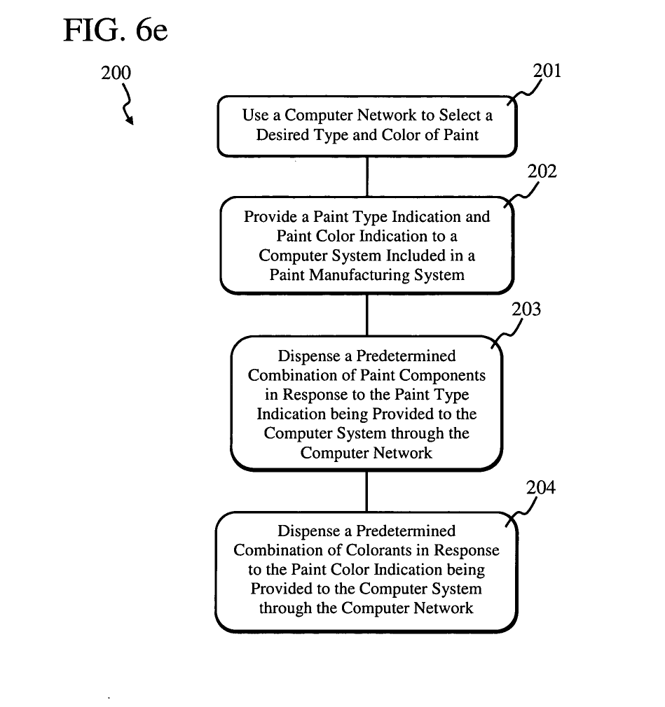

FIG. 6a is a block diagram of a method 180, in accordance with the invention, of ordering paint. In this embodiment, method 180 includes a step 181 of using a computer network to select a desired type of paint. The desired type of paint is generally selected using a web browser. Method 180 includes a step 182 of providing a paint type indication, which corresponds with the desired type of paint, to a computer system included in a paint manufacturing system. The paint type indication is provided by the computer network to the computer system through a communication link.

Method 180 includes a step 183 of dispensing, with the paint manufacturing system, at least two paint components to form the desired type of paint. The paint components are dispensed at the point of sale. The paint components are combined together, such as by mixing, at the point of sale. In accordance with the invention, the paint components are selected from a group that includes a pigment composition, a dispersant thickening agent, and a resin content binder. In one particular embodiment, the paint components include a resin content binder, and a pigment composition and/or dispersant thickening agent. In accordance with the invention, the paint components are contained in separate containers before they are combined together.

It should be noted that method 180 can include many other steps. For example, in some embodiments, method 180 includes a step of paying for the paint using the computer network. It should be noted, however, that the paint can be paid for at the point of sale, and in many other ways. Method 180 can also include a step of shipping the paint, such as to his or her house or business. It should be noted, however, that the paint can be picked-up at the point of sale. For example, the consumer can go to the point of sale and retrieve the paint.

FIG. 6b is a block diagram of a method 185, in accordance with the invention, of ordering a desired type of paint. In this embodiment, method 185 includes a step 186 of using a computer network to select the desired type of paint. Method 185 includes a step 187 of providing a paint type indication, which corresponds with the desired type of paint, to a computer system included in a paint manufacturing system. In one embodiment, the paint type indication is provided to the computer system through the computer network. The paint manufacturing system also includes a dispenser operatively coupled to the computer system. It should be noted that the dispenser and computer system are typically located at the point of sale.

Method 185 includes a step 188 of dispensing, with the dispenser, a predetermined combination of paint components in response to the paint type indication being provided to the computer system through the computer network. The desired paint is formed in response to the paint components being dispensed. The dispenser dispenses at least two paint components in response to the paint type indication. It should be noted that the paint components are typically dispensed at the point of sale.

FIG. 6c is a block diagram of a method 190, in accordance with the invention, of ordering a desired type of paint. In this embodiment, method 190 includes a step 191 of using a computer network to select the desired type of paint. Method 190 includes a step 192 of providing a paint type indication, which corresponds with the desired type of paint, to a computer system included in a paint manufacturing system. The computer system is typically in communication with the computer network through a communication link. The paint manufacturing system also includes a dispenser and paint component storage system operatively coupled to the computer system. It should be noted that the computer system, dispenser and paint component storage system are typically located at the point of sale.

Method 190 includes a step 193 of flowing, from the paint component storage system, a predetermined combination of paint components in response to a paint type indication being provided to the computer system through the computer network. Method 190 includes a step 194 of dispensing the predetermined combination of paint components through the dispenser, wherein the paint components are dispensed at the point of sale.

FIG. 6d is a block diagram of a method 195, in accordance with the invention, of ordering paint. In this embodiment, method 195 includes a step 196 of using a computer network to select the desired type of paint. Method 195 includes a step 197 of providing a paint type indication, which corresponds with the desired type of paint, to a computer system included in a paint manufacturing system. In this embodiment, the paint manufacturing system also includes a dispenser and a computer network in communication with the computer system. Method 195 includes a step 198 of dispensing a predetermined combination of paint components in response to the paint type indication being provided to the computer system through the computer network. The desired paint is formed in response to the paint components being dispensed.

In some embodiments, the paint manufacturing system of method 195 includes a colorant storage system operatively coupled to the computer system, wherein the colorant storage system is in fluid communication with the dispenser. In these embodiments, method 195 can include using the computer network to select a desired color of paint and a step of flowing a paint color indication to the computer system. In response to the paint color indication, a predetermined combination of colorants from the colorant storage system are flowed to the dispenser. The colorants are dispensed by the dispenser and combined with the paint components.

In some embodiments, the paint manufacturing system of method 195 includes an additive storage system operatively coupled to the computer system, wherein the additive storage system is in fluid communication with the dispenser. In these embodiments, method 195 can include flowing a predetermined additive from the additive storage system to the dispenser in response to a paint additive indication. The paint additive indication is provided to the computer system through the computer network. The predetermined additive is dispensed by the dispenser and combined with the paint components.

FIG. 6e is a block diagram of a method 200, in accordance with the invention, of ordering a desired type and color of paint. In this embodiment, method 200 includes a step 201 of using a computer network to select the desired type and color of paint. Method 200 includes a step 202 of providing a paint type indication and paint color indication to a computer system included in a paint manufacturing system. In accordance with the invention, the paint type and color indications are provided to the computer system through the computer network. The paint type indication corresponds with the desired type of paint and the paint color indication corresponds with the desired color of paint.

In this embodiment, the paint manufacturing system also includes a dispenser in fluid communication with the paint component and colorant storage systems. Further, the paint component and colorant storage systems are operatively coupled to the computer system. It should be noted that the computer system, dispenser and paint component and colorant storage systems are typically located at the point of sale. Further, a portion of the computer network, such as an internet server, can be located at the point of sale.

Method 200 includes a step 203 of dispensing a predetermined combination of paint components in response to the paint type indication being provided to the computer system through the computer network. The desired paint is formed in response to the paint components being dispensed. In step 203, the paint components are flowed from the paint component storage system to the dispenser in response to the paint type indication being provided to the computer system through the computer network.

Method 200 includes a step 204 of dispensing a predetermined combination of colorants in response to the paint color indication being provided to the computer system through the computer network. The colorants drive the color of the paint components to match the desired color. The colorants drive the color of the paint components to match the desired color when the colorants are combined with the paint components. In step 204, the colorants are flowed from the colorant storage system to the dispenser in response to the paint color indication being provided to the computer system through the computer network.

In some embodiments, the paint manufacturing system of method 200 includes an additive storage system operatively coupled to the computer system, wherein the additive storage system is in fluid communication with the dispenser. In these embodiments, method 200 can include flowing a predetermined combination of additive(s) from the additive storage system to the dispenser in response to a paint additive indication. The paint additive indication is provided to the computer system through the computer network. The additive(s) are dispensed by the dispenser and combined with the paint components. It should be noted that the predetermined combination of additive(s) can be one or more additives.

It should be noted that the steps in the methods discussed in FIGS. 5a-5e and 6a-6e can be carried out in many different orders other than the ones described here. Further, the steps in the different methods can be combined together in many ways. It should also be noted that, in any of the embodiments of the methods discussed in FIGS. 5a-5e and 6a-6e, the paint type and color indications can be provided to the computer system through an input device, such as a keyboard or touch-screen display. However, in accordance with the invention, the paint type and color indications are provided to the computer system through the computer network. In this way, the paint type and color indications are provided remotely.

The embodiments of the invention described herein are exemplary and numerous modifications, variations and rearrangements can be readily envisioned to achieve substantially equivalent results, all of which are intended to be embraced within the spirit and scope of the invention.

1. A paint manufacturing system, comprising:
a computer system in communication with a computer network; and
a dispenser which dispenses a predetermined combination of paint components in response to a paint type indication being provided to the computer system through the computer network.

2. The system of claim 1, wherein a desired paint is formed in response to the paint components being dispensed.

3. The system of claim 1, wherein the dispenser dispenses at least two paint components in response to the paint type indication.

4. The system of claim 1, further including a paint component storage system operatively coupled to the computer system, the paint component storage system being in fluid communication with the dispenser.

5. The system of claim 4, wherein the paint component storage system flows the predetermined combination of paint components to the dispenser in response to the paint type indication.

6. The system of claim 1, further including a colorant storage system operatively coupled to the computer system, the colorant storage system being in fluid communication with the dispenser.

7. The system of claim 6, wherein the colorant storage system flows a predetermined combination of colorants to the dispenser in response to a paint color indication.

8. The system of claim 7, wherein the paint color indication is provided to the computer system through the computer network.

9. The system of claim 1, further including an additive storage system operatively coupled to the computer system, the additive storage system being in fluid communication with the dispenser.

10. The system of claim 9, wherein the additive storage system flows a predetermined additive to the dispenser in response to a paint additive indication.

11. A paint manufacturing system, comprising:
a dispenser;
a paint component storage system in fluid communication with the dispenser;
a computer system operatively coupled to the paint component storage system; and
a computer network in communication with the computer system;
wherein the paint component storage system flows a desired amount of at least two types of paint components to the dispenser in response to a paint type indication provided to the computer system through the computer network.

12. The system of claim 11, wherein the computer network includes an internet server in communication with the computer system.

13. The system of claim 11, wherein a desired type of paint is formed in response to the paint components being dispensed.

14. The system of claim 11, further including a colorant storage system operatively coupled to the computer system, the colorant storage system being in fluid communication with the dispenser.

15. The system of claim 14, wherein the colorant storage system flows a predetermined combination of colorants to the dispenser in response to a paint color indication.

16. The system of claim 15, wherein the paint color indication is provided to the computer system through the computer network.

17. The system of claim 11, further including an additive storage system operatively coupled to the computer system, the additive storage system being in fluid communication with the dispenser.

18. The system of claim 17, wherein the additive storage system flows a desired additive to the dispenser in response to a paint additive indication.

19. A method of manufacturing paint, comprising:
providing a paint manufacturing system which includes a computer system in communication with a computer network, and a dispenser which dispenses a predetermined combination of paint components in response to a paint type indication being provided to the computer system through the computer network; and
providing the paint type indication to the computer system through the computer network.

20. The method of claim 19, further including forming a desired paint in response to the paint type indication.

21. The method of claim 19, wherein the step of providing the paint manufacturing system includes providing an internet server in communication with the computer system.

22. The method of claim 19, further including providing the paint manufacturing system with a colorant storage system operatively coupled to the computer system, the colorant storage system being in fluid communication with the dispenser.

23. The method of claim 22, further including flowing a predetermined combination of colorants from the colorant storage system to the dispenser in response to a paint color indication.

24. The method of claim 23, further including providing the paint color indication to the computer system through the computer network.

25. The method of claim 19, further including providing the paint manufacturing system with an additive storage system operatively coupled to the computer system, the additive storage system being in fluid communication with the dispenser.

26. The method of claim 25, further including flowing a predetermined combination of additive(s) from the additive storage system to the dispenser in response to a paint additive indication.

27. The method of claim 26, further including providing the paint additive indication to the computer system through the computer network.
